(19) United States
(12) Patent Application Publication
(10) Pub. No.: US 2023/0037174 A1
(43) Pub. Date: Feb. 2, 2023

(54) FOLDING ELECTRONIC DEVICE

(71) Applicant: TPK Advanced Solutions Inc., Xiamen (CN)

(72) Inventors: Tu Teng Shen, Xiamen City (CN); Hui Li, Xiamen City (CN)

(21) Appl. No.: 17/385,977

(22) Filed: Jul. 27, 2021

(51) Int. Cl. G06F 1/16

(52) U.S. Cl. CPC G06F 1/1616; G06F 1/1681; G06F 1/1656; G06F 1/1652

(57) ABSTRACT

A folding electronic device includes a supporting base, a first structure, a second structure, a flexible screen, and a screen supporting structure. The first structure includes a first body, a protruding portion, and a first shaft connected between the first body and the protruding portion and pivotally connected with the supporting base. The second structure includes a second body and a second shaft pivotally connected with the supporting base and connected with the second body. The second body forms an included angle with the first body. The flexible screen connects with the first body and the second body. The screen supporting structure movably connects with the supporting base. The screen supporting structure is at least partially located between the first structure and the second structure. When the included angle is 180 degrees, the protruding portion contacts the screen supporting structure, and the screen supporting structure contacts the flexible screen.

### BACKGROUND

### Technical Field

The present disclosure relates to folding electronic devices.

### Description of Related Art

With the increasing living standard of people, electronic products have become an indispensable part in daily lives. To match with the change of the living patterns of people, the types and models of the electronic products in the market have a wide variety. Among these products, folding electronic devices, such as smart phones or tablets, are welcomed by many consumers.

To fulfill the demand of the consumers, for the folding electronic devices, the way to properly fold the screen is undoubtedly an important direction of development of the industry. For example, the U.S. Pat. No. 9,857,832B2 has disclosed a folding electronic device 10 (please refer to FIGS. 1-2 of the instant application). The flexible screen 20 of the folding electronic device 10 can be opened or folded when the folding electronic device 10 is opened or closed. The folding electronic device 10 provides support to the flexible screen 20 by the supporting pieces 30 and 40.

However, reference is made to FIG. 3 of the instant application. FIG. 3 is a diagram presenting the action of the supporting pieces 30 and 40 of FIGS. 1-2. Obviously, as shown in FIG. 3, it is clear that the positions where the supporting pieces 30 and 40 touch the flexible screen 20 will change (move from the contact point E on the flexible screen 20 to the contact point F, taking the supporting piece 30 as an example) with regard to the angle by which the folding electronic device 10 is opened. Therefore, the folding electronic device 10 has the chance to scratch the flexible screen 20 due to friction.

The present disclosure can at least solve the problem above. That is, apart from allowing a folding electronic device to maintain its flexible screen to be flat during usage, the present disclosure can further avoid the chance of scratching the flexible screen when the folding electronic device is switched between a usage state and a storage state.

### SUMMARY

A technical aspect of the present disclosure is to provide a folding electronic device, which can make the flexible screen maintain a flat state in the usage state and can avoid the chance of scratching the flexible screen when the folding electronic device is switched between the usage state and the storage state.

According to an embodiment of the present disclosure, a folding electronic device includes a supporting base, a first structure, a second structure, a flexible screen, and a screen supporting structure. The first structure includes a first body, a protruding portion, and a first shaft. The first shaft is pivotally connected with the supporting base along a first axis. The first shaft is connected between the first body and the protruding portion. The second structure includes a second body and a second shaft. The second body forms an included angle with the first body. The second shaft is connected with the second body. The second shaft is pivotally connected with the supporting base along a second axis. The second axis is parallel with the first axis. The flexible screen is connected with the first body and the second body. The screen supporting structure is movably connected with the supporting base. The screen supporting structure is at least partially located between the first structure and the second structure. When the included angle is 180 degrees, the protruding portion contacts the screen supporting structure, and the screen supporting structure at least partially contacts the flexible screen.

In one or more embodiments of the present disclosure, the supporting base includes a base plate, a top plate, and at least one connecting portion. The top plate has at least one through hole. The connecting portion is connected between the top plate and the base plate. The top plate and the base plate define a space therebetween. The space communicates with the through hole. The screen supporting structure includes a screen supporting plate, at least one limiting portion, and at least one connecting rod. The screen supporting plate is configured to at least partially contact the flexible screen. The limiting portion is located in the space. The limiting portion is configured to abut the top plate. The connecting rod penetrates through the through hole. The connecting rod is connected between the screen supporting plate and the limiting portion.

In one or more embodiments of the present disclosure, the protruding portion is at least partially located between the screen supporting plate and the base plate.

According to an embodiment of the present disclosure, a folding electronic device includes a supporting base, a first structure, a second structure, a flexible screen, and a screen supporting structure. The first structure includes a first body, a first protruding portion, and a first shaft. The first shaft is pivotally connected with the supporting base along a first axis. The first shaft is connected between the first body and the first protruding portion. The second structure includes a second body, a second protruding portion, and a second shaft. The second shaft is pivotally connected with the supporting base along a second axis. The second shaft is connected between the second body and the second protruding portion. The second shaft is parallel with the first axis. The flexible screen is connected with the first body and the second body. The screen supporting structure is movably connected with the supporting base. The screen supporting structure is at least partially located between the first structure and the second structure. When the included angle is 180 degrees, the first protruding portion and the second protruding portion contact the screen supporting structure, and the screen supporting structure at least partially contacts the flexible screen.

In one or more embodiments of the present disclosure, the supporting base includes a base plate, a top plate, and at least one connecting portion. The top plate has at least one through hole. The connecting portion is connected between the top plate and the base plate. The top plate and the base plate define a space therebetween. The space communicates with the through hole. The screen supporting structure includes a screen supporting plate, at least one limiting portion, and at least one connecting rod. The screen supporting plate is configured to at least partially contact the flexible screen. The limiting portion is located in the space. The limiting portion is configured to abut the top plate. The connecting rod penetrates through the through hole. The connecting rod is connected between the screen supporting plate and the limiting portion.

In one or more embodiments of the present disclosure, the first protruding portion and the second protruding portion are respectively at least partially located between the screen supporting plate and the base plate.

In one or more embodiments of the present disclosure, the first shaft and the second shaft are configured to rotate synchronously.

According to an embodiment of the present disclosure, a folding electronic device includes a supporting base, a first structure, a second structure, a flexible screen, a screen supporting structure, and an elastic element. The first structure includes a first body, a protruding portion, and a first shaft. The first shaft is pivotally connected with the supporting base along a first axis. The first shaft is connected between the first body and the protruding portion. The second structure includes a second body and a second shaft. The second body forms an included angle with the first body. The second shaft is connected with the second body. The second shaft is pivotally connected with the supporting base along a second axis. The second axis is parallel with the first axis. The flexible screen is connected with the first body and the second body. The screen supporting structure is movably connected with the supporting base. The screen supporting structure is at least partially located between the first structure and the second structure. The protruding portion is configured to abut the screen supporting structure to make the screen supporting structure contact the flexible screen. The elastic element is elastically connected between the screen supporting structure and the supporting base. When the included angle is 0 degrees, the protruding portion and the screen supporting structure are separated from each other, and the screen supporting structure and the flexible screen are separated from each other.

In one or more embodiments of the present disclosure, the supporting base includes a base plate, a top plate, and at least one connecting portion. The top plate has at least one through hole. The connecting portion is connected between the top plate and the base plate. The top plate and the base plate define a space therebetween. The space communicates with the through hole. The screen supporting structure includes a screen supporting plate, at least one limiting portion, and at least one connecting rod. The screen supporting plate is configured to at least partially contact the flexible screen. The limiting portion is located in the space. The limiting portion is configured to abut the top plate. The elastic element is connected between the top plate and the limiting portion. The connecting rod penetrates through the through hole. The connecting rod is connected between the screen supporting plate and the limiting portion.

In one or more embodiments of the present disclosure, the elastic element is a spring. The connecting rod penetrates through the elastic element.

In one or more embodiments of the present disclosure, the protruding portion is at least partially located between the screen supporting plate and the base plate.

When compared with the prior art, the above-mentioned embodiments of the present disclosure have at least the following advantage:

(1) When the included angle between the first body and the second body is increased to 180 degrees from an angle less than 180 degrees, the first protruding portion of the first structure and the second protruding portion of the second structure respectively at least partially abut the screen supporting plate of the screen supporting structure, such that the screen supporting plate moves towards the flexible screen relative to the supporting base and at least partially contacts the flexible screen in order to provide support to the flexible screen, which can make the flexible screen maintain the flat state in a simple and easy manner.

(2) When the included angle between the first body and the second body is increased to 180 degrees from an angle less than 180 degrees, since the screen supporting plate moves towards the flexible screen along the normal direction of the flexible screen and at least partially contacts the flexible screen, the screen supporting plate will not slide over the surface of the flexible screen. Thus, the chance to scratch the flexible screen by the screen supporting plate can be avoided.

(3) When the included angle between the first body and the second body is reduced to 0 degrees from an angle larger than 0 degrees, the first protruding portion and the second protruding portion are respectively separated from the screen supporting structure. Then, the compressed elastic element is elastically recovered and the elastic potential energy stored is released. Thus, the screen supporting plate of the screen supporting structure moves towards the supporting base and is able to move away from the flexible screen in a simple and easy manner.

(4) When the included angle between the first body and the second body is reduced to 0 degrees from an angle larger than 0 degrees, the first protruding portion and the second protruding portion are respectively separated from the screen supporting structure. Thus, through the compression of the flexible screen to the screen supporting plate, the screen supporting structure is able to move towards the base plate of the supporting base in a simple and easy manner, which helps the folding electronic device to change back to the storage state.

### BRIEF DESCRIPTION OF THE DRAWINGS

The disclosure can be more fully understood by reading the following detailed description of the embodiments, with reference made to the accompanying drawings as follows:

FIGS. 1-2 are schematic views of a folding electronic device as disclosed by U.S. Pat. No. 9,857,832B2;

FIG. 3 is a diagram presenting the action of the supporting pieces of FIGS. 1-2;

FIG. 4 is a schematic view of a folding electronic device according to an embodiment of the present disclosure, in which the folding electronic device is in a storage state;

FIG. 5 is a schematic view of the folding electronic device of FIG. 4, in which the included angle between the first body and the second body is 60 degrees;

FIG. 6 is a schematic view of the folding electronic device of FIG. 4, in which the included angle between the first body and the second body is 120 degrees;

FIG. 7 is a schematic view of the folding electronic device of FIG. 4, in which the included angle between the first body and the second body is 180 degrees, and the folding electronic device is currently in a usage state;

FIG. 8 is a schematic view of the folding electronic device of FIG. 7, in which the flexible screen is omitted;

FIG. 9 is a schematic view of the folding electronic device of FIG. 8, in which both the flexible screen and the screen supporting plate are omitted;

FIG. 10 is a partially enlarged view of the area A of FIG. 9;

FIG. 11 is a section view along the section line B-B of FIG. 10;

FIG. 12 is a section view along the section line C-C of FIG. 10;

FIG. 13 is a section view along the section line D-D of FIG. 4;

FIG. 14 is a section view along the section line E-E of FIG. 4;

FIG. 15 is a section view of a folding electronic device according to another embodiment of the present disclosure, in which the elastic element is elastically connected between the screen supporting structure and the supporting base;

FIG. 16 is a section view of the folding electronic device of FIG. 15, in which the elastic element is recovered; and

FIG. 17 is a section view of a folding electronic device according to a further embodiment of the present disclosure, in which the flexible screen at least partially abuts the screen supporting structure and makes the screen supporting structure move towards the supporting base.

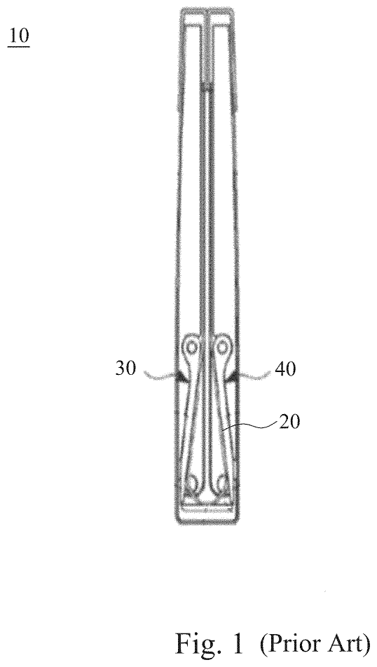

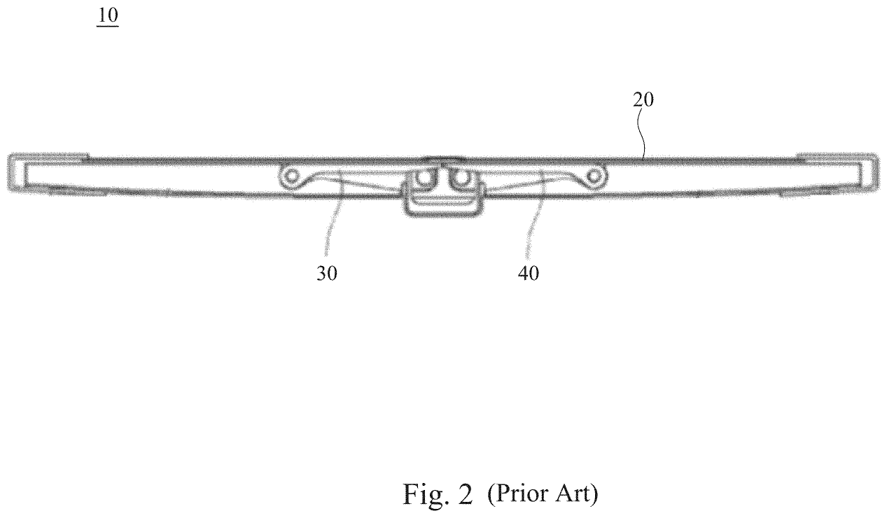

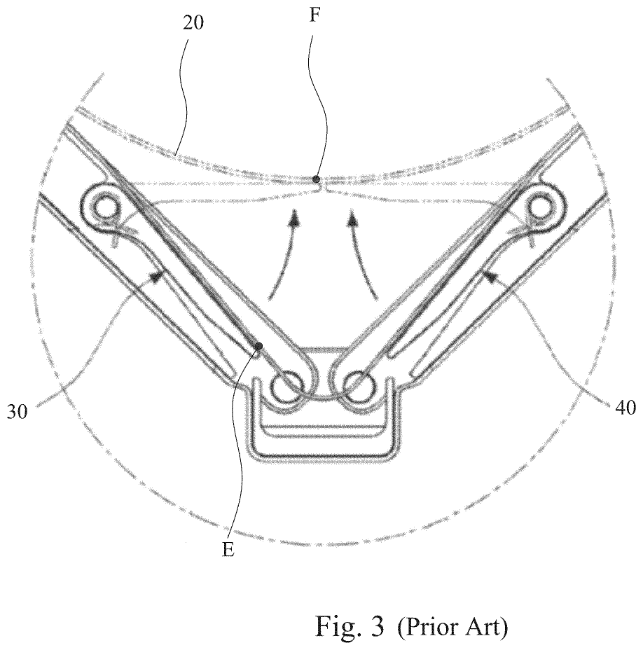

### DETAILED DESCRIPTION

Drawings will be used below to disclose embodiments of the present disclosure. For the sake of clear illustration, many practical details will be explained together in the description below. However, it is appreciated that the practical details should not be used to limit the claimed scope. In other words, in some embodiments of the present disclosure, the practical details are not essential. Moreover, for the sake of drawing simplification, some customary structures and elements in the drawings will be schematically shown in a simplified way. Wherever possible, the same reference numbers are used in the drawings and the description to refer to the same or like parts.

Unless otherwise defined, all terms (including technical and scientific terms) used herein have the same meanings as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

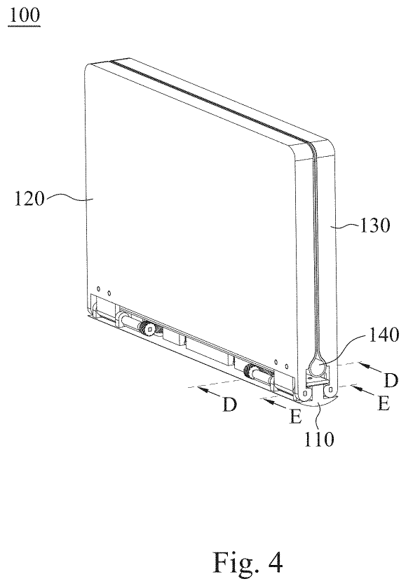

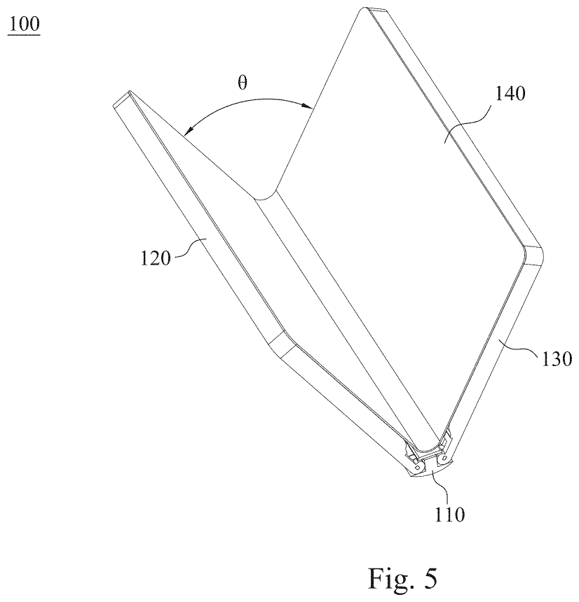

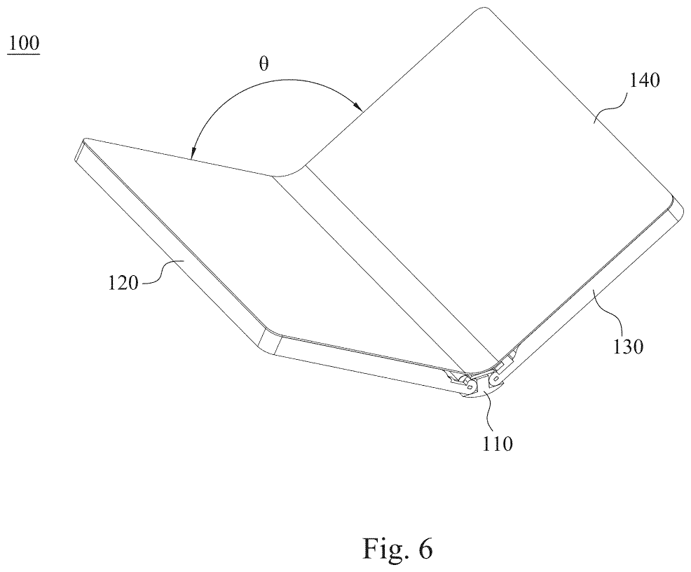

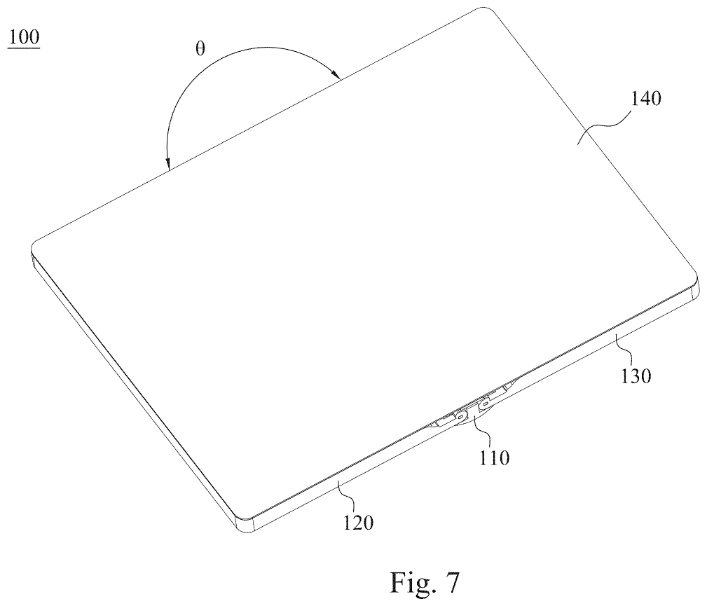

Reference is made to FIGS. 4-7. FIG. 4 is a schematic view of a folding electronic device 100 according to an embodiment of the present disclosure, in which the folding electronic device 100 is in a storage state. FIG. 5 is a schematic view of the folding electronic device 100 of FIG. 4, in which an included angle θ between a first body 121 of a first structure 120 and a second body 131 of a second structure 130 is 60 degrees. FIG. 6 is a schematic view of the folding electronic device 100 of FIG. 4, in which the included angle θ between the first body 121 and the second body 131 is 120 degrees. FIG. 7 is a schematic view of the folding electronic device 100 of FIG. 4, in which the included angle θ between the first body 121 and the second body 131 is 180 degrees, and the folding electronic device 100 is in a usage state. In this embodiment, as shown in FIGS. 4-7, a folding electronic device 100 includes a supporting base 110, the first structure 120, the second structure 130, and a flexible screen 140. The first structure 120 and the second structure 130 are pivotally connected with the supporting base 110 respectively. The flexible screen 140 is connected with the first structure 120 and the second structure 130. In practical applications, the folding electronic device 100 can be a smart phone or a tablet. However, the type of the folding electronic device 100 is not intended to limit the present disclosure.

To be specific, when the folding electronic device 100 is in the storage state as shown in FIG. 4, the folding electronic device 100 can be easily stored by a user. At this point, the first structure 120 and the second structure 130 are close to each other, and the flexible screen 140 is in a folded state. When the folding electronic device 100 is gradually opened, the included angle θ between the first structure 120 and the second structure 130 is also gradually increased. As shown in FIGS. 5-6, the included angle θ between the first structure 120 and the second structure 130 is respectively 60 degrees and 120 degrees, and the flexible screen 140 is also gradually opened and tends to become flat. When the folding electronic device 100 is in the usage state as shown in FIG. 7, the included angle θ between the first structure 120 and the second structure 130 is 180 degrees and the flexible screen 140 is in a flat state, facilitating the operation by the user. In other words, when the folding electronic device 100 is switched between the storage state and the usage state, the shape of the flexible screen 140 changes from the folded state to the flat state or changes from the flat state to the folded state.

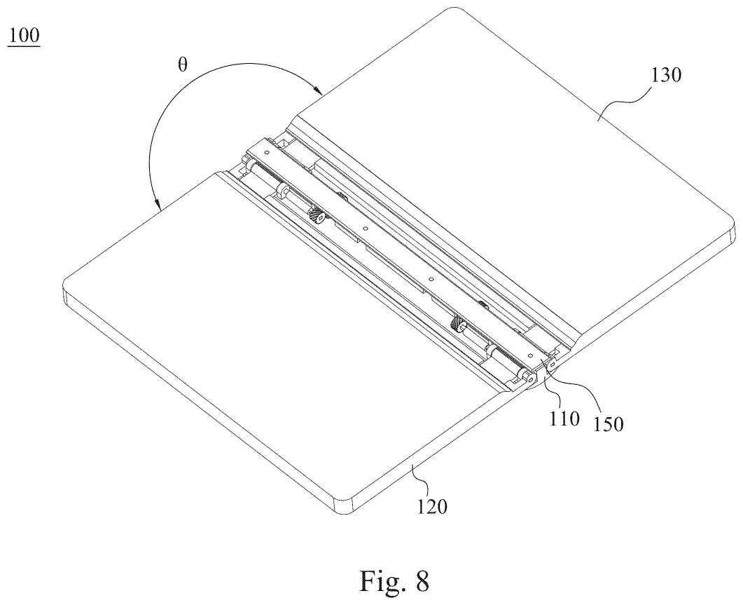

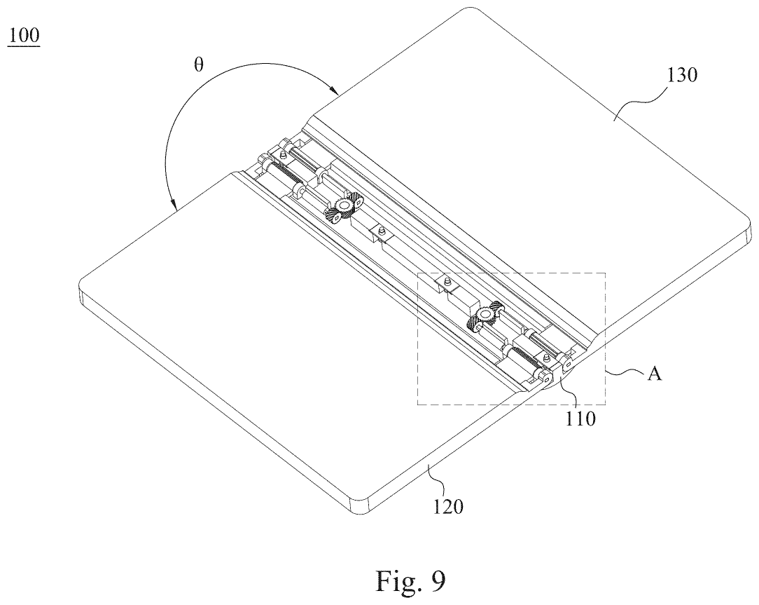

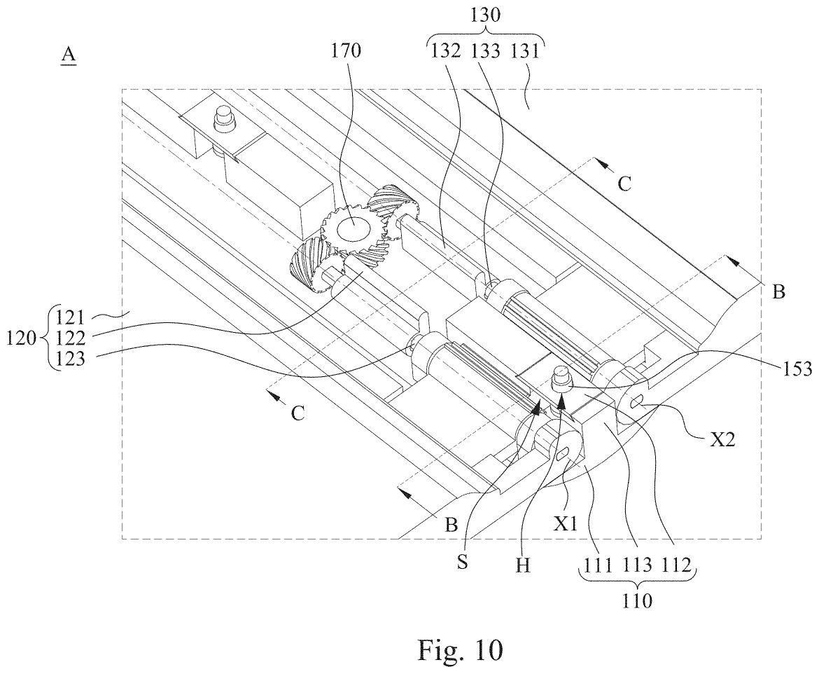

Reference is made to FIGS. 8-10. FIG. 8 is a schematic view of the folding electronic device 100 of FIG. 7, in which the flexible screen 140 is omitted. FIG. 9 is a schematic view of the folding electronic device 100 of FIG. 8, in which both the flexible screen 140 and a screen supporting plate 151 of a screen supporting structure 150 are omitted. FIG. 10 is a partially enlarged view of the area A of FIG. 9. In this embodiment, as shown in FIGS. 8-10, the folding electronic device 100 further includes the screen supporting structure 150. In addition, the first structure 120 includes the first body 121, a first protruding portion 122, and a first shaft 123. The first shaft 123 is connected between the first body 121 and the first protruding portion 122, and the first shaft 123 is pivotally connected with the supporting base 110 along a first axis X1. The second structure 130 includes the second body 131, a second protruding portion 132, and a second shaft 133. The second body 131 of the second structure 130 and the first body 121 of the first structure 120 form the included angle θ mentioned above therebetween. The second shaft 133 is connected between the second body 131 and the second protruding portion 132, and the second shaft 133 is pivotally connected with the supporting base 110 along a second axis X2. The second shaft 133 is parallel with the first axis X1. To be specific, the first shaft 123 and the second shaft 133 can rotate synchronously through mechanical linkage. For example, through a gear set 170 mechanically connected between the first structure 120 and the second structure 130, the first structure 120 and the second structure 130 become close to each other or move away from each other simultaneously. Moreover, the screen supporting structure 150 is at least partially located between the first structure 120 and the second structure 130 and is movably connected with the supporting base 110.

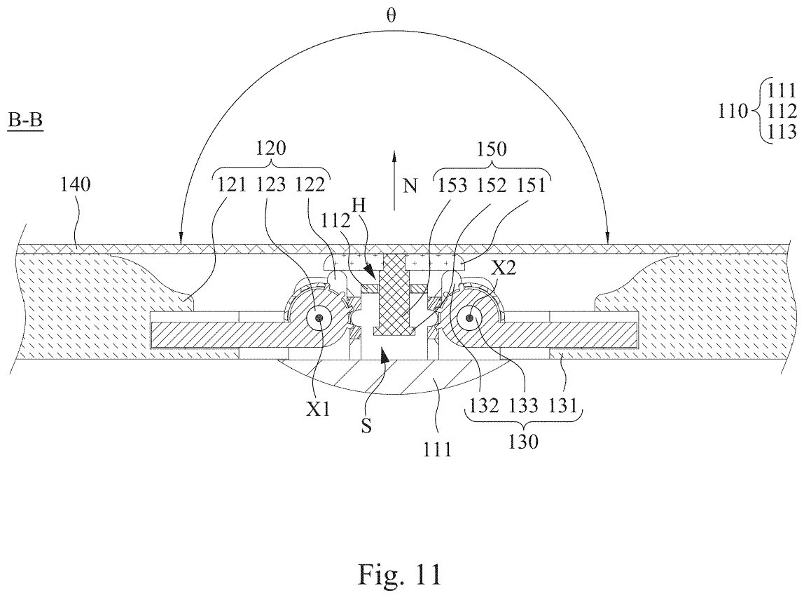

Reference is made to FIGS. 10-11. FIG. 11 is a section view along the section line B-B of FIG. 10. In this embodiment, as shown in FIGS. 10-11, the supporting base 110 includes a base plate 111, a top plate 112, and at least one connecting portion 113. The top plate 112 has at least one through hole H. The connecting portion 113 is connected between the top plate 112 and the base plate 111. The top plate 112 and the base plate 111 define a space S therebetween. The space S communicates with the through hole H. Moreover, the screen supporting structure 150 includes the screen supporting plate 151, at least one limiting portion 152, and at least one connecting rod 153 (please refer to FIG. 11 for the screen supporting plate 151, the limiting portion 152, and the connecting rod 153). The screen supporting plate 151 is configured to at least partially contact the flexible screen 140 (the flexible screen 140 is omitted in FIGS. 8-10, please refer to FIG. 11). The limiting portion 152 is located in the space S and its dimension is larger than the through hole H of the top plate 112. Thus, the limiting portion 152 is not able to pass through the through hole H, and the limiting portion 152 is configured to abut the top plate 112 of the supporting base 110 in order to prevent the screen supporting structure 150 from detaching from the supporting base 110. The connecting rod 153 is connected between the screen supporting plate 151 and the limiting portion 152. The connecting rod 153 penetrates through the through hole H of the top plate 112. In other words, the top plate 112 is located between the screen supporting plate 151 and the limiting portion 152. Furthermore, as shown in FIG. 11, the flexible screen 140 is connected with the first body 121 of the first structure 120 and the second body 131 of the second structure 130. When the included angle θ between the first body 121 and the second body 131 is 180 degrees, the screen supporting plate 151 moves towards the flexible screen 140 relative to the supporting base 110, and the screen supporting plate 151 at least partially contacts the flexible screen 140 to provide support to the flexible screen 140. Thus, the flexible screen 140 can be maintained in the flat state.

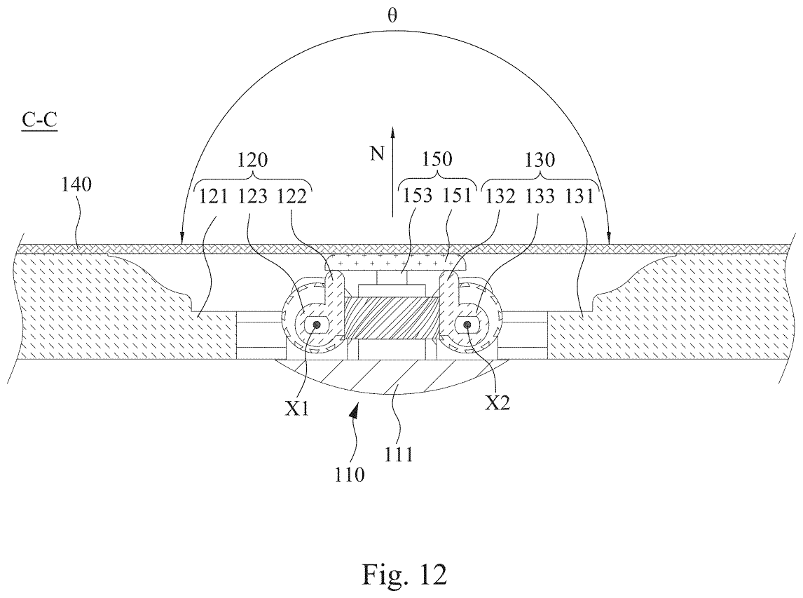

Reference is made to FIG. 12. FIG. 12 is a section view along the section line C-C of FIG. 10. In this embodiment, the first protruding portion 122 of the first structure 120 and the second protruding portion 132 of the second structure 130 are respectively at least partially located between the screen supporting plate 151 and the base plate 111. In addition, as shown in FIG. 12, when the included angle θ is increased to 180 degrees from an angle less than 180 degrees, with the rotations of the first structure 120 and the second structure 130, the first protruding portion 122 and the second protruding portion 132 respectively at least partially abut the screen supporting plate 151, such that the screen supporting plate 151 is able to move towards the flexible screen 140 along the normal direction N of the flexible screen 140. Thus, the screen supporting plate 151 at least partially contacts the flexible screen 140 in order to provide support to the flexible screen 140, which can make the flexible screen 140 maintain the flat state in a simple and easy manner. Moreover, as shown in FIG. 11, the limiting portion 152 of the screen supporting structure 150 also moves towards the top plate 112 of the supporting base 110. It is worth noting that, since the screen supporting plate 151 moves towards the flexible screen 140 along the normal direction N of the flexible screen 140 and at least partially contacts the flexible screen 140, the screen supporting plate 151 will not slide over the surface of the flexible screen 140. Thus, the chance to scratch the flexible screen 140 by the screen supporting plate 151 can be avoided.

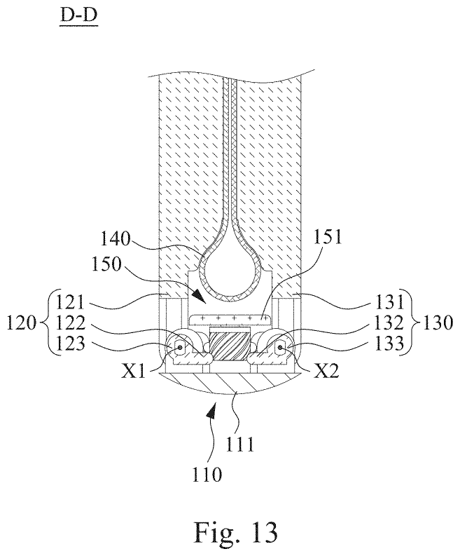

Reference is made to FIG. 13. FIG. 13 is a section view along the section line D-D of FIG. 4. In this embodiment, as shown in FIG. 13, when the folding electronic device 100 is in the storage state, i.e., the included angle θ between the second body 131 and the first body 121 changes to 0 degrees from an angle larger than 0 degrees, the first protruding portion 122 and the second protruding portion 132 respectively rotate with the first structure 120 and the second structure 130 and no longer abut the screen supporting plate 151 of the screen supporting structure 150. In other words, when the included angle θ is 0 degrees, the first protruding portion 122 and the second protruding portion 132 are respectively separated from the screen supporting structure 150. That is, the first protruding portion 122 and the second protruding portion 132 no longer provide support to the screen supporting plate 151. At this point, the screen supporting structure 150 can move towards the base plate 111 of the supporting base 110 by, for example, its own weight. Thus, the screen supporting structure 150 can move away from the flexible screen 140, and the screen supporting structure 150 and the flexible screen 140 are separated from each other. In this way, the screen supporting structure 150 can release a space to accommodate the part of the flexible screen 140 being folded.

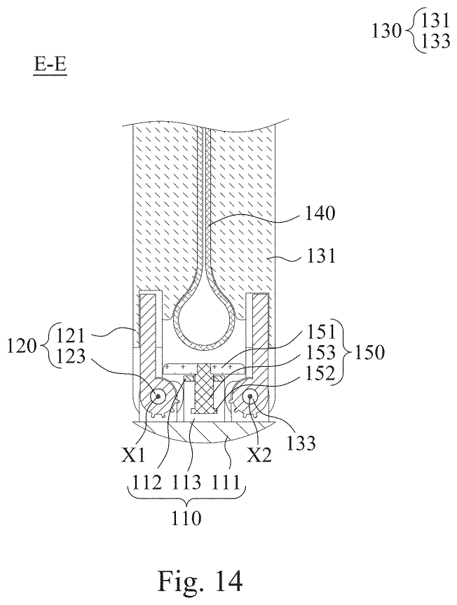

Reference is made to FIG. 14. FIG. 14 is a section view along the section line E-E of FIG. 4. In this embodiment, as shown in FIG. 14, when the included angle θ is 0 degrees, the screen supporting plate 151 of the screen supporting structure 150 loses the support from the first protruding portion 122 and the second protruding portion 132, and the limiting portion 152 of the screen supporting structure 150 also moves towards the base plate 111 and away from the top plate 112 of the supporting base 110.

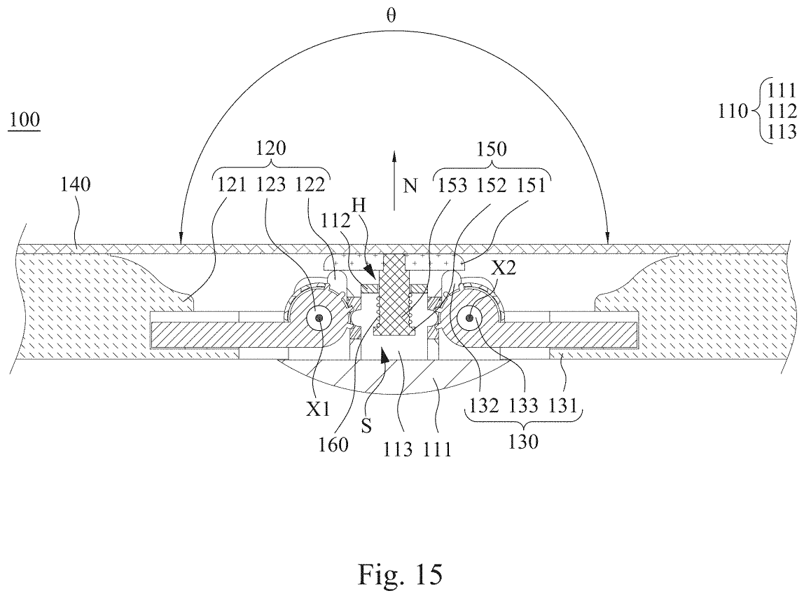

Reference is made to FIG. 15. FIG. 15 is a section view of a folding electronic device 100 according to another embodiment of the present disclosure, in which an elastic element 160 is elastically connected between the screen supporting structure 150 and the supporting base 110. In this embodiment, the folding electronic device 100 further includes the elastic element 160. For example, in practical applications, the elastic element 160 can be a spring. However, this is not intended to limit the present disclosure. As shown in FIG. 15, the elastic element 160 is elastically connected between the limiting portion 152 of the screen supporting structure 150 and the top plate 112 of the supporting base 110, and the connecting rod 153 penetrates through the elastic element 160. When the folding electronic device 100 is in the usage state, i.e., when the included angle θ between the first body 121 and the second body 131 is increased to 180 degrees from an angle less than 180 degrees, as mentioned above, the first protruding portion 122 and the second protruding portion 132 respectively rotate with the first structure 120 and the second structure 130 and then at least partially abut the screen supporting plate 151, such that the screen supporting plate 151 moves towards the flexible screen 140 along the normal direction N of the flexible screen 140 and at least partially contacts the flexible screen 140. At the same time, the limiting portion 152 of the screen supporting structure 150 also moves towards the top plate 112 of the supporting base 110, such that the elastic element 160 connected between the top plate 112 and the limiting portion 152 is compressed and shorten, which stores a certain amount of elastic potential energy.

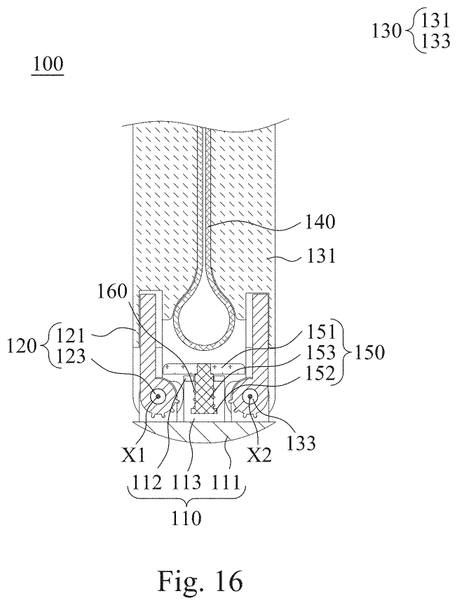

Reference is made to FIG. 16. FIG. 16 is a section view of the folding electronic device 100 of FIG. 15, in which the elastic element 160 is recovered. In this embodiment, as shown in FIG. 16, when the folding electronic device 100 is in the storage state, i.e., when the included angle θ between the first body 121 and the second body 131 is reduced to 0 degrees from an angle larger than 0 degrees, as mentioned above, the first protruding portion 122 and the second protruding portion 132 respectively rotate with the first structure 120 and the second structure 130 and no longer abut the screen supporting plate 151. In other words, when the included angle θ between the first body 121 and the second body 131 is 0 degrees, the first protruding portion 122 and the second protruding portion 132 are respectively separated from the screen supporting structure 150. That is, the first protruding portion 122 and the second protruding portion 132 no longer provide support to the screen supporting plate 151. Then, the compressed elastic element 160 is elastically recovered and the elastic potential energy stored is released. Thus, the screen supporting plate 151 of the screen supporting structure 150 moves towards the supporting base 110 and is able to move away from the flexible screen 140 in a simple and easy manner. At this point, the screen supporting structure 150 and the flexible screen 140 are separated from each other.

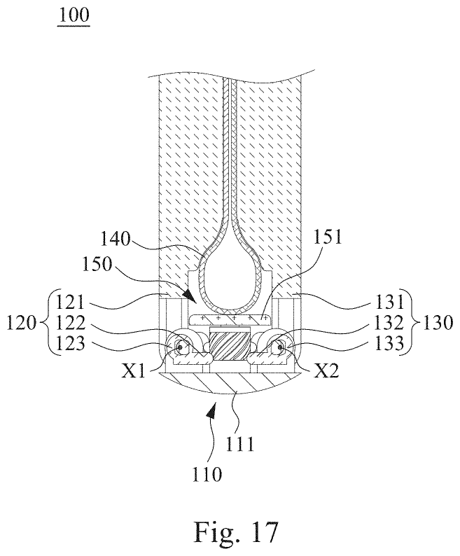

Reference is made to FIG. 17. FIG. 17 is a section view of a folding electronic device 100 according to a further embodiment of the present disclosure, in which the flexible screen 140 at least partially abuts the screen supporting structure 150 and makes the screen supporting structure 150 move towards the supporting base 110. In this embodiment, as shown in FIG. 17, when the included angle θ between the first body 121 and the second body 131 is reduced to 0 degrees from an angle larger than 0 degrees, the flexible screen 140 at least partially abuts the screen supporting plate 151 of the screen supporting structure 150, such that the screen supporting structure 150 moves to the base plate 111 of the supporting base 110. To be specific, as mentioned above, when the included angle θ between the first body 121 and the second body 131 is 0 degrees, the first protruding portion 122 of the first structure 120 and the second protruding portion 132 of the second structure 130 are respectively separated from the screen supporting structure 150. That is, the first protruding portion 122 and the second protruding portion 132 no longer provide support to the screen supporting plate 151. Thus, through the compression of the flexible screen 140 to the screen supporting plate 151, the screen supporting structure 150 is able to move towards the base plate 111 of the supporting base 110 in a simple and easy manner, which helps the folding electronic device 100 to change back to the storage state.

In conclusion, when compared with the prior art, the aforementioned embodiments of the present disclosure have at least the following advantages:

(1) When the included angle between the first body and the second body is increased to 180 degrees from an angle less than 180 degrees, the first protruding portion of the first structure and the second protruding portion of the second structure respectively at least partially abut the screen supporting plate of the screen supporting structure, such that the screen supporting plate moves towards the flexible screen relative to the supporting base and at least partially contacts the flexible screen in order to provide support to the flexible screen, which can make the flexible screen maintain the flat state in a simple and easy manner.

(2) When the included angle between the first body and the second body is increased to 180 degrees from an angle less than 180 degrees, since the screen supporting plate moves towards the flexible screen along the normal direction of the flexible screen and at least partially contacts the flexible screen, the screen supporting plate will not slide over the surface of the flexible screen. Thus, the chance to scratch the flexible screen by the screen supporting plate can be avoided.

(3) When the included angle between the first body and the second body is reduced to 0 degrees from an angle larger than 0 degrees, the first protruding portion and the second protruding portion are respectively separated from the screen supporting structure. Then, the compressed elastic element is elastically recovered and the elastic potential energy stored is released. Thus, the screen supporting plate of the screen supporting structure moves towards the supporting base and is able to move away from the flexible screen in a simple and easy manner.

(4) When the included angle between the first body and the second body is reduced to 0 degrees from an angle larger than 0 degrees, the first protruding portion and the second protruding portion are respectively separated from the screen supporting structure. Thus, through the compression of the flexible screen to the screen supporting plate, the screen supporting structure is able to move towards the base plate of the supporting base in a simple and easy manner, which helps the folding electronic device to change back to the storage state.

Although the present disclosure has been described in considerable detail with reference to certain embodiments thereof, other embodiments are possible. Therefore, the spirit and scope of the appended claims should not be limited to the description of the embodiments contained herein.

It will be apparent to the person having ordinary skill in the art that various modifications and variations can be made to the structure of the present disclosure without departing from the scope or spirit of the present disclosure. In view of the foregoing, it is intended that the present disclosure cover modifications and variations of the present disclosure provided they fall within the scope of the following claims.

What is claimed is:

1. A folding electronic device, comprising:
a supporting base;
a first structure, comprising:
a first body;
a protruding portion; and
a first shaft pivotally connected with the supporting base along a first axis and connected between the first body and the protruding portion;
a second structure, comprising:
a second body forming an included angle with the first body; and
a second shaft connected with the second body and pivotally connected with the supporting base along a second axis parallel with the first axis;
a flexible screen connected with the first body and the second body; and
a screen supporting structure movably connected with the supporting base and at least partially located between the first structure and the second structure,
wherein, when the included angle is 180 degrees, the protruding portion contacts the screen supporting structure, and the screen supporting structure at least partially contacts the flexible screen.

2. The folding electronic device of claim 1, wherein the supporting base comprises:
a base plate;
a top plate having at least one through hole; and
at least one connecting portion connected between the top plate and the base plate, wherein the top plate and the base plate define a space therebetween, and the space communicates with the through hole, wherein the screen supporting structure comprises:
a screen supporting plate configured to at least partially contact the flexible screen;
at least one limiting portion located in the space and configured to abut the top plate; and
at least one connecting rod penetrating through the through hole and connected between the screen supporting plate and the limiting portion.

3. The folding electronic device of claim 2, wherein the protruding portion is at least partially located between the screen supporting plate and the base plate.

4. A folding electronic device, comprising:
a supporting base;
a first structure, comprising:
a first body;
a first protruding portion; and
a first shaft pivotally connected with the supporting base along a first axis and connected between the first body and the first protruding portion;
a second structure, comprising:
a second body forming an included angle with the first body;
a second protruding portion; and
a second shaft pivotally connected with the supporting base along a second axis and connected between the second body and the second protruding portion, the second shaft being parallel with the first axis;
a flexible screen connected with the first body and the second body; and
a screen supporting structure movably connected with the supporting base and at least partially located between the first structure and the second structure,
wherein, when the included angle is 180 degrees, the first protruding portion and the second protruding portion contact the screen supporting structure, and the screen supporting structure at least partially contacts the flexible screen.

5. The folding electronic device of claim 4, wherein the supporting base comprises:
a base plate;
a top plate having at least one through hole; and
at least one connecting portion connected between the top plate and the base plate, wherein the top plate and the base plate define a space therebetween, and the space communicates with the through hole,
wherein the screen supporting structure comprises:
a screen supporting plate configured to at least partially contact the flexible screen;
at least one limiting portion located in the space and configured to abut the top plate; and
at least one connecting rod penetrating through the through hole and connected between the screen supporting plate and the limiting portion.

6. The folding electronic device of claim 5, wherein the first protruding portion and the second protruding portion are respectively at least partially located between the screen supporting plate and the base plate.

7. The folding electronic device of claim 4, wherein the first shaft and the second shaft are configured to rotate synchronously.

8. A folding electronic device, comprising:
a supporting base;
a first structure, comprising:
a first body;
a protruding portion; and
a first shaft pivotally connected with the supporting base along a first axis and connected between the first body and the protruding portion;
a second structure, comprising:
a second body forming an included angle with the first body; and
a second shaft connected with the second body and pivotally connected with the supporting base along a second axis parallel with the first axis;
a flexible screen connected with the first body and the second body;
a screen supporting structure movably connected with the supporting base and at least partially located between the first structure and the second structure, the protruding portion being configured to abut the screen supporting structure to make the screen supporting structure contact the flexible screen; and
an elastic element elastically connected between the screen supporting structure and the supporting base,
wherein, when the included angle is 0 degrees, the protruding portion and the screen supporting structure are separated from each other, and the screen supporting structure and the flexible screen are separated from each other.

9. The folding electronic device of claim 8, wherein the supporting base comprises:
a base plate;
a top plate having at least one through hole; and
at least one connecting portion connected between the top plate and the base plate, wherein the top plate and the base plate define a space therebetween, and the space communicates with the through hole,
the screen supporting structure comprises:
a screen supporting plate configured to at least partially contact the flexible screen;
at least one limiting portion located in the space and configured to abut the top plate, wherein the elastic element is connected between the top plate and the limiting portion; and
at least one connecting rod penetrating through the through hole and connected between the screen supporting plate and the limiting portion.

10. The folding electronic device of claim 9, wherein the elastic element is a spring, and the connecting rod penetrates through the elastic element.

11. The folding electronic device of claim 9, wherein the protruding portion is at least partially located between the screen supporting plate and the base plate.
